(19) United States
(12) Patent Application Publication
(10) Pub. No.: US 2016/0078327 A1
(43) Pub. Date: Mar. 17, 2016

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Jun Wakamatsu, Kanagawa (JP)

(21) Appl. No.: 14/621,505

(22) Filed: Feb. 13, 2015

(30) Foreign Application Priority Data
Sep. 12, 2014 (JP) 2014-185982

(51) Int. Cl. G06K 15/02

(52) U.S. Cl. CPC G06K 15/1818

(57) ABSTRACT

An information processing apparatus includes a virtual machine configuration unit, a comparing unit and a determining unit. The virtual machine configuring unit configures a first virtual machine on which a same image processing program as an old version of an image processing program installed on an image processing apparatus is installed and a second virtual machine on which to new version of the image processing program provided for updating the old version of the image processing program is installed. The comparing unit compares output images from the first and the second virtual machines in response to a same instruction to process an image being input into the first and the second virtual machines. The determining unit determines a validity of update on the basis of a comparison result by the comparing unit.

### CROSS-REFERENCE TO RELATED APPLICATIONS

This application is based on and claims priority under 35 USC 119 from Japanese Patent Application No. 2014-185982 filed on Sep. 12, 2014.

### BACKGROUND

### Technical Field

The present invention relates to an information processing apparatus and a non-transitory computer readable medium.

### SUMMARY

An aspect of the present invention provides an information processing apparatus including: a holding unit that holds a first image processing program that is a same image processing program as an old version of an image processing program installed on an image processing apparatus and allows a computer to function as a first image processing unit and a second image processing program that is a new version of the image processing program provided for updating the old version of the image processing program and allows the computer to function as a second image processing unit; a loading unit that loads each of the first image processing program and the second image processing program into the computer; a comparing unit that compares output images from the first image processing unit and the second image processing unit in response to a same instruction to process an image being input into the first image processing unit and the second image processing unit; and a determining unit that determines a validity of update on the basis of a comparison result by the comparing unit.

### BRIEF DESCRIPTION OF THE DRAWINGS

Exemplary embodiment(s) of the present invention will be described in detail based on the following figures, wherein

FIG. 1 is a diagram illustrating an example of a printing system;

FIG. 2 is a diagram illustrating an example of an information processing system;

FIG. 3 is a diagram illustrating arm example of the operation of a configuration management unit;

FIG. 4 is a diagram illustrating an example of the operation of a virtual machine;

FIG. 5 is a diagram illustrating an example of the operation of a comparing unit;

FIG. 6 is a diagram illustrating another example of the information processing system;

FIG. 7 is a diagram illustrating another example of the information processing system; and

FIG. 8 is a diagram illustrating an example of the operation of the printing system.

### DETAILED DESCRIPTION

An exemplary embodiment(s) of the present invention will be described with reference to the drawings.

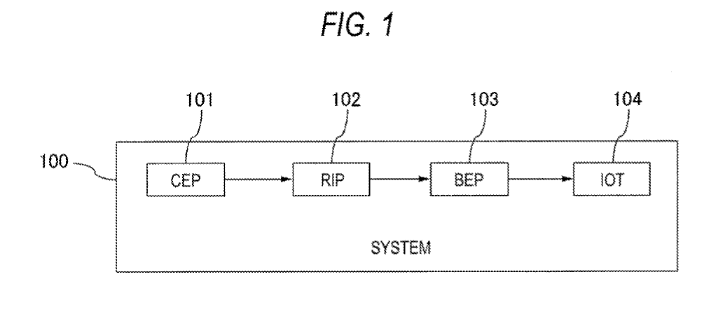

FIG. 1 is a diagram illustrating an example of a printing system 100. The printing system 100 is an example of an image processing apparatus and is provided with a center processor (CEP) 101, a raster image processor (RIP) 102, a back end processor (BEP) 103, and an image output terminal (IOT) 104.

The RIP 102 and the BEP 103 generate image data on the basis of a print job registered in the CEP 101. The print job is an example of an instruction to form an image. The IOT 104 forms on a paper medium the image data generated by the RIP 102 and the BEP 103.

The CEP 101, the RIP 102, and the BEP 103 are functional units based on software and are realized by a CPU executing a program stored in a memory in a computer that is configured by the CPU, the memory, and the like. The IOT 104 is a piece of hardware that forms an image on a paper medium.

The CEP 101 is a functional unit that inputs and edits data, controls the system, and performs such functions. The CEP 101 transmits to the RIP 102 an instruction to generate the image data on the basis of a registered print job.

The RIP 102 generates intermediate image data according to the instruction to generate the image data from the CEP 101 and transmits the intermediate image data to the BEP 103. The intermediate image data is common data that is not dependent on the type of the IOT 104 and is image data at a stage prior to the generation of the final raster image.

The BEP 103 generates the raster image on the basis of the image data from the RIP 102 and transmits the raster image to the IOT 104. In addition, the BEP 103 performs a coloring process. The BEP 103 transmits to the IOT 104 control data for forming the generated raster image on the paper medium.

The IOT 104 forms an image on the paper medium according to the raster image and the control data from the BEP 103.

Incidentally, a general printing system is thoroughly verified before the operation thereof is initiated. For this, upgrading the version of software is likely to be avoided once the operation is initiated. This is because problems such as a change in the output result and the like may be posed when the version is upgraded.

Therefore, in the present embodiment, the verification work is facilitated by the operation of an information processing system 1 described below.

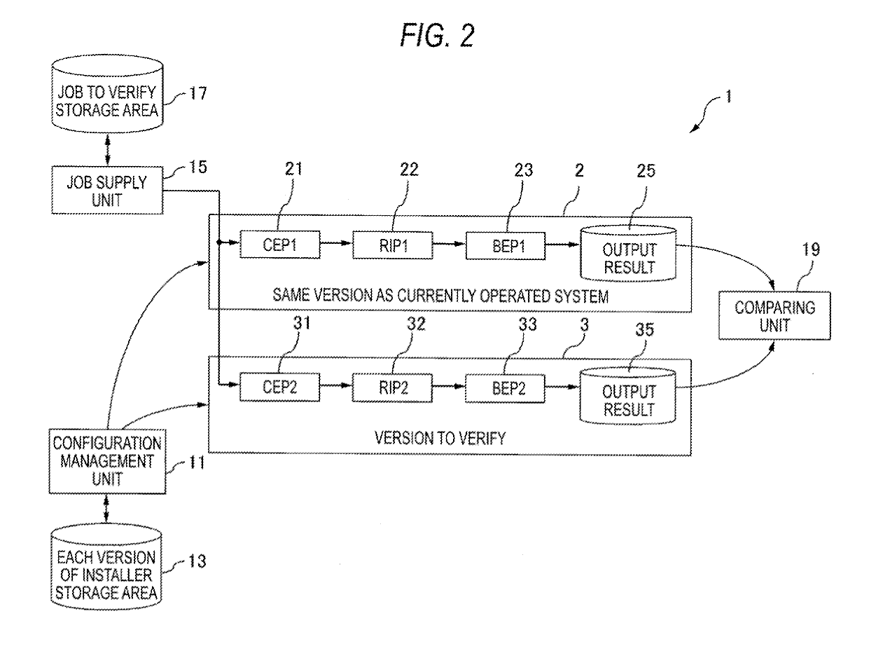

FIG. 2 is a diagram illustrating an example of the information processing system 1. The information processing system 1 (an example of an information processing apparatus), for example, is a distributed computing environment that is also called a cloud service. The information processing system 1 includes a plurality of web application servers, a plurality of database servers, a plurality of storage devices, and the like, all of which are connected to each other communicably.

A server included in the information processing system 1 is provided with a computer that is configured by a CPU, a memory, and the like. The server realizes a configuration management unit 11 (an example of loading unit and virtual machine configuring unit), an installer storage area 13 (an example of holding unit), a job supply unit 15, a job to verify storage area 17, and a comparing unit 19 (an example of comparing unit and determining unit) by the CPU executing a program stored in the memory.

The information processing system 1 further realizes virtual machines (emulator) 2 and 3 by the operation of the configuration management unit 11. Each of the virtual machines 2 and 3 are an example of image processing unit. The virtual machines 2 and 3, for example, are realized in the following manner.

The information processing system 1 includes a physical machine that is connected to the configuration management unit 11. A hypervisor is installed on the physical machine, and the virtual machines 2 and 3 are launched on the hypervisor. The hypervisor is a piece of software that launches and controls the virtual machines 2 and 3 on the physical machine without requiring the help of a versatile OS. The virtual machines 2 and 3 are a set of a CPU and a memory that is virtually created as known in the related art. The physical machine is apparently a computer that is formed by a CPU, a memory, and the like.

The configuration management unit 11 reads a installer (a program) from the installer storage area 13 in order to realize the virtual machines 2 and 3. The configuration management unit 11 launches the virtual machines 2 and 3 by loading the installer. The virtual machines 2 and 3 are provided with CEPs 21 and 31, RIPs 22 and 32, and BEPs 23 and 33 in a similar manner to the printing system 100 illustrated in FIG. 1. The virtual machines 2 and 3 are further provided with output result holding units 25 and 35 that hold the output result of the BEPs 23 and 33. The output results, for example, are output images that are output from the BEPs 23 and 33. The output result may include the control data.

In the present embodiment, the virtual machine 2, for example, is launched by the same image processing program as that of an old version installed on the printing system 100 that is currently operated. The virtual machine 3, for example, is launched by a new version of the image processing program that is provided for updating the old version of the image processing program.

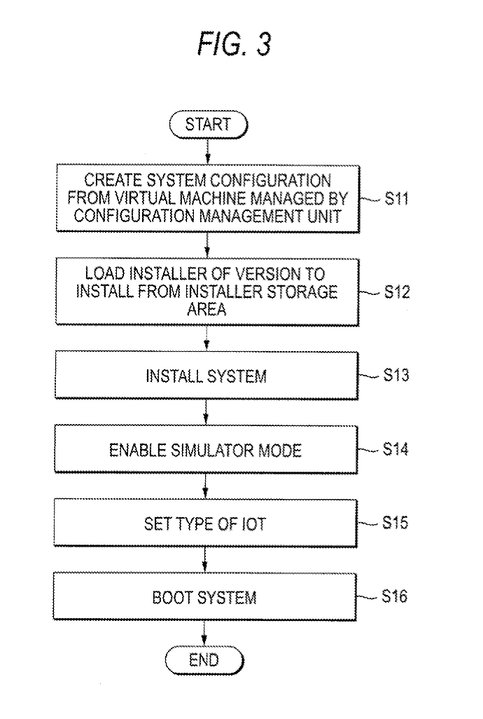

The launch of the virtual machines 2 and 3 are performed specifically in the manner illustrated in the flowchart of FIG. 3. First, a system configuration is created from the virtual machines 2 and 3 that are managed by the configuration management unit 11 (S11). The installer of a version to install is loaded from the installer storage area 13 (S12), and the system is installed (S13). Then, a simulator mode is enabled (S14), the type of the IOT 104 is set (S15), and the system is booted (S16).

Returning to the description of FIG. 2, the job supply unit 15 reads a print job to verify from the job to verify storage area 17, supplies the print job to verify to the CEPs 21 and 31 of the virtual machines 2 and 3, and registers the print job to verify in the CEPs 21 and 31. Accordingly, the CEPs 21 and 31, the RIPs 22 and 32, and the BEPs 23 and 33 of the virtual machines 2 and 3 process the same print job. The output results of the BEPs 23 and 33 are held in the output result holding units 25 and 35.

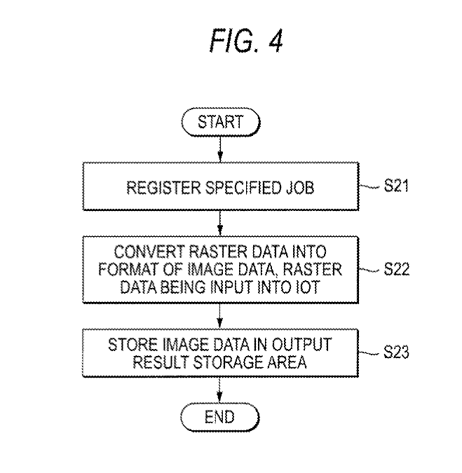

The registration of the print job and the holding of the output result are performed specifically in the manner illustrated in the flowchart of FIG. 4. First, the print job specified is registered in the CEPs 21 and 31 of the virtual machines 2 and 3 (S21). Raster data (that is, the output results of the BEPs 23 and 33) that is to be input into the IOT 104 is converted into the format of the image data (S22), and the image data is stored in the output result holding units 25 and 35 (S23).

Returning to the description of FIG. 2, the comparing unit 19 obtains each output result of the BEPs 23 and 33 from the output result holding units 25 and 35 of the virtual machines 2 and 3 and compares both of the output results. Specifically, the comparing unit 19 compares the output results of the BEPs 23 and 33 in binary. Comparing in binary means comparing two files in binary base. The comparing unit 19 then determines whether the match ratio between the output results of the BEPs 23 and 33 is greater than a threshold.

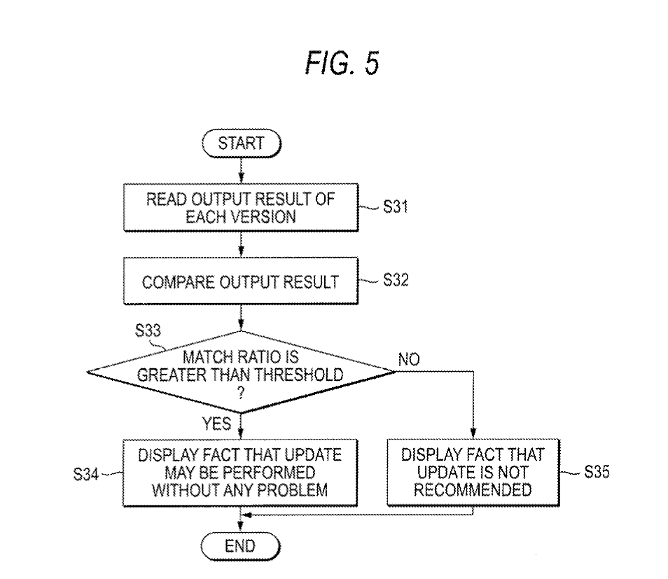

The comparison between the output result of the BEPs 23 and 33 is performed specifically in the manner illustrated in the flowchart of FIG. 5. First, the output results of the BEPs 23 and 33 are read from the output result holding units 25 and 35 of the virtual machines 2 and 3 (S31). The output results are compared (S32), and a determination is made on whether the match ratio therebetween is greater than the threshold (S33). When the match ratio is greater than the threshold (YES in S33), the comparing unit 19 displays the fact that the update may be performed without any problem (S34). Meanwhile, when the match ratio is less than or equal to the threshold (NO in S33), the comparing unit 19 displays the fact that the update is not recommended (S35).

The update here means replacing the old version of the image processing program installed on the currently operated printing system 100 with the new version of the image processing program. That is to say, when the match ratio between the output result of the virtual machine 2 launched by the old version of the image processing program and the output result of the virtual machine 3 launched by the new version of the image processing program is greater than the threshold, it is determined that the old version of the image processing program installed on the currently operated printing system 100 may be updated to the new version of the image processing program without any problem.

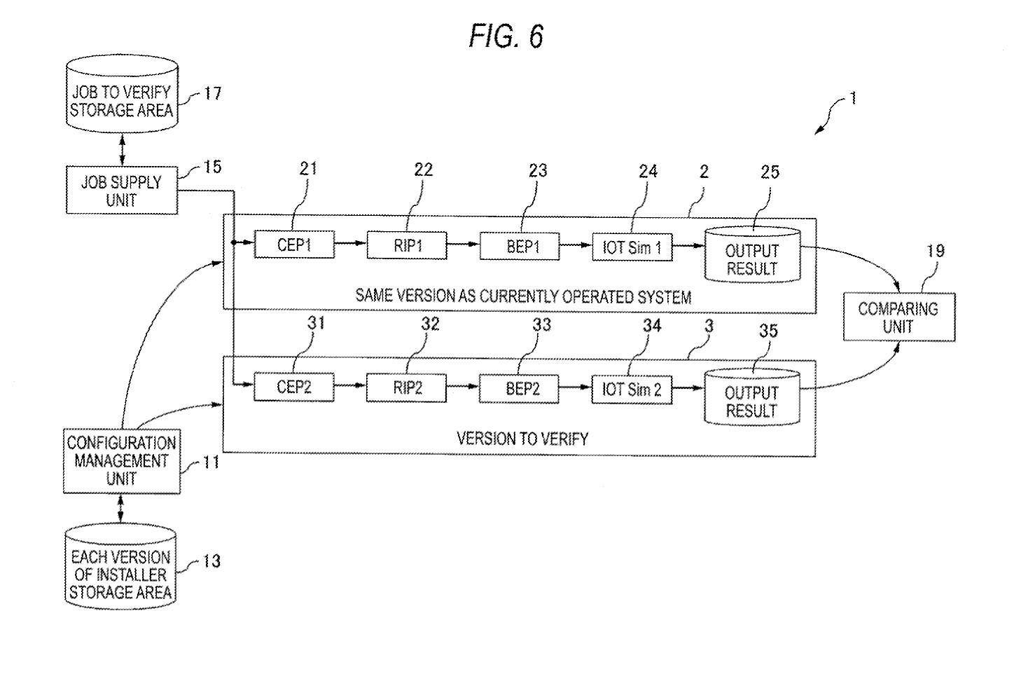

FIG. 6 is a diagram illustrating another example of the information processing system 1. The same configurations as those in the above embodiment are given the same numbers and will not be described in detail. When the IOT 104 (refer to FIG. 1) of the printing system 100 includes a functional unit based on software and a piece of hardware to form an image, the virtual machines 2 and 3 may be provided with IOT Sims 24 and 34 that correspond to the functional unit based on software in the IOT 104. In the present example, the output results of the IOT Sims 24 and 34 are held in the output result holding units 25 and 35 and are compared by the comparing unit 19.

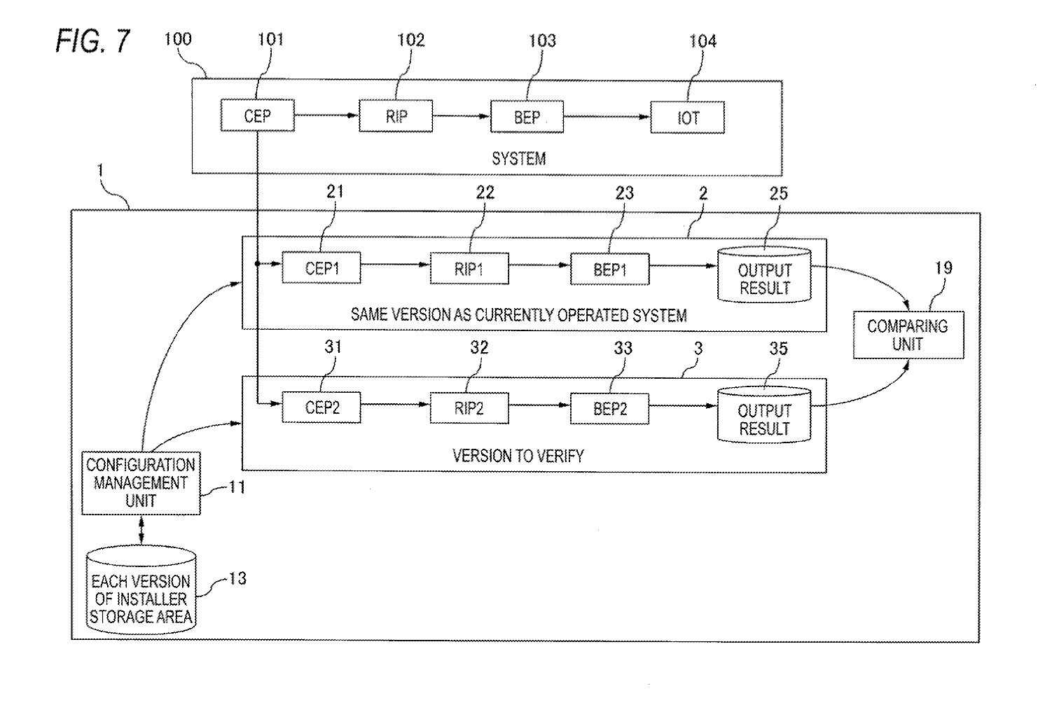

FIG. 7 is a diagram illustrating another example of the information processing system 1. The same configurations as those in the above embodiment are given the same numbers and will not be described in detail. The print job registered in the CEPs 21 and 31 of the virtual machines 2 and 3 may be supplied from the currently operated printing system 100.

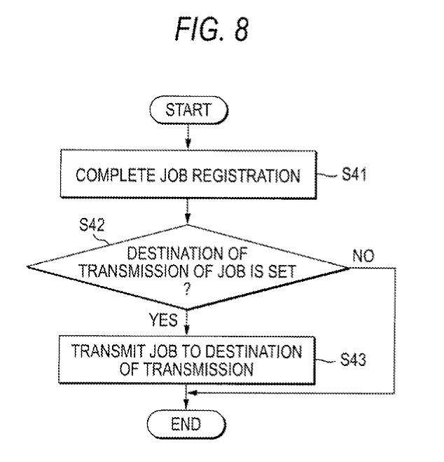

The supply of the print job is performed specifically in the manner illustrated in the flowchart of FIG. 8. First, when the print job is registered in the CEP 101 of the printing system 100 (S41), the CEP 101 determines whether the destination of transmission of the print job is set (S42). When the destination of transmission is set (YES in S42), the CEP 101 transmits the print job to the destination of transmission (S43). Accordingly, the print job is registered in the CEPs 21 and 31 of the virtual machines 2 and 3 from the printing system 100.

According, to the present embodiment described above, a new version of a program can be verified while the current operation of the priming system 100 is continued. Thus, the verification work can be facilitated.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a holding unit that holds a first image processing program that is a same image processing program as an old version of an image processing program installed on an image processing apparatus and allows a computer to function as a first image processing unit and a second image processing program that is a new version of the image processing program provided for updating the old version of the image processing program and allows the computer to function as a second image processing unit;
a loading unit that loads each of the first image processing program and the second image processing program into the computer;
a comparing unit that compares output images from the first image processing unit and the second image processing unit in response to a same instruction to process an image being input into the first image processing unit and the second image processing unit and a determining unit that determines a validity of update on the basis of a comparison result by the comparing unit.

2. The information processing apparatus according to claim 1,
wherein the comparing unit compares the output images from the first image processing unit and the second image processing unit in binary.

3. The information processing apparatus according to claim 1,
wherein the instruction to process the image is supplied from the image processing apparatus on which the old version of the image processing program is installed.

4. An information processing apparatus comprising:
a virtual machine configuring unit that configures a first virtual machine on which a same image processing program as an old version of an image processing program installed on an image processing apparatus is installed and a second virtual machine on which a new version of the image processing program provided for updating the old version of the image processing program is installed;
a comparing unit that compares output images from the first and the second virtual machines in response to a same instruction to process an image being input into the first and the second virtual machines; and
a determining unit that determines a validity of update on the basis of a comparison result by the comparing unit.

5. A non-transitory computer readable medium storing a program causing a computer to execute a process for information processing, the process comprising:
holding a first image processing program that is a same image processing program as an old version of an image processing program installed on an image processing apparatus and allows a computer to function as a first image processing unit and a second image processing program that is a new version of the image processing program provided for updating the old version of the image processing program and allows the computer to function as a second image processing unit;
loading each of the first image processing program and the second image processing program into the computer;
comparing output images from the first image processing unit and the second image processing unit in response to a same instruction to process an image being input into the first image processing unit and the second image processing unit; and
determining a validity of update on the basis of a comparison result of the comparing.

6. A non-transitory computer readable medium storing a program causing as computer to execute a process for information processing, the process comprising:
a virtual machine configuring unit that configures a first virtual machine on which a same image processing program as an old version of an image processing program installed on an image processing apparatus is installed and a second virtual machine on which a new version of the image processing program provided for updating the old version of the image processing program is installed;
a comparing unit that compares output images front the first and the second virtual machines in response to a same instruction to process an image being input into the first and the second virtual machines; and
a determining unit that determines a validity of update on the basis of a comparison result by the comparing unit.
